(19) United States
(12) Patent Application Publication
(10) Pub. No.: US 2004/0083246 A1
(43) Pub. Date: Apr. 29, 2004

(54) Method and system for performance management in a computer system

(76) Inventors: Hakim Kahlouche, Saint-Laurent (CA); Shafiek Savahl, Melbourne (AU); Steeve Juneau, Saint-Hubert (CA)

Correspondence Address: SANDRA BEAUCHESNE, Ericsson Canada Inc., Patent Department (LMC/I/P), 8400 Decarie Blvd., Town Mount Royal, QC, H4P 2N2, CA

(21) Appl. No.: 10/279,792

(22) Filed: Oct. 25, 2002

(51) Int. Cl. G06F 9/00; G06F 11/30

(52) U.S. Cl. 708/105; 714/38

(57) ABSTRACT

A method and system for performance management, wherein software applications processes run on one or more processors of monitored systems. One or more process collector monitoring processes retrieve performance measurements from the application processes and relay the measurements to a processor collector monitoring process on each processor. The former may aggregate the measurements based on various measurements' types, and sends the created performance scan data to a system collector server, that receives such performance scan data from a plurality of processors, alternatively performs further data aggregation and issues alarms based on predefined thresholds. Performance scan data is temporarily stored in a scan database, further sent under XML format to a file system repository, or accessible to consumers at requested time intervals. The performance management system is configurable via a configurator manager that distributes performance scan attributes, including counters, gauges, and status inspections to the system.

### BACKGROUND OF THE INVENTION

1. Field of the Invention

The present invention relates to network management, and in particular to a method and system for computer system's performance management.

2. Description of the Related Art

Network management systems and performance management systems are widely used in the industry in order to retrieve information about the functioning of various types of computer networks and systems. They typically provide information to network administrators about the quality of the service provided by the systems themselves.

Although there is no prior art solution as the one proposed hereinafter, an example of a known management system is provided in the U.S. Pat. No. 5,825,775 issued to Chin et al., herein called Chin. In the U.S. Pat. No. 5,825,775, Chin teaches a method and apparatus for generating a display containing information about both local and remote traffic handled by a router. Local messages are routed between devices on a first local area network, while remote messages are routed between the first local area network and a second local area network. An integrated router stores a set of values related to the local messages. The network management station executes the network management application, which causes the network management station to generate the display of the management information stored in the integrated router. In response to user inputs, the network management station requests the information from the integrated router, receives the information from the integrated router, and generates the display of the information, which may include charts that illustrate statistics derived from the information.

The international patent application WO 95/22216 published in the name of Green et al, herein called Green, also bears some relation with the field of the present invention. Green teaches a repeater information base for accumulating management data from a network repeater and for providing the portion of the accumulated data to a CPU in response to commands from the CPU. The method includes the steps of separating the management data into individual bits, polling the individual bits, generating a management memory address, reading, incrementing, and writing back the contents of the attributes actuation register.

However, despite the fact that various network management systems are described in the literature, the prior art fails to provide an efficient, reliable, and scalable performance management system and method for efficient reporting of performance information about the monitored network. The present invention provides such a method and system.

### SUMMARY OF THE INVENTION

In one aspect, the present invention is a Performance Management System (PMS) comprising a monitored computer system that includes a processor where one or more software application processes run. The PMS further includes a process collector monitoring process collecting performance measurements from the software application process and a processor collector monitoring process running on the processor and connected to said process collector monitoring process, wherein said processor collector monitoring process collects said performance measurements from the process collector monitoring process. In the PMS, a system collector server collects performance scan data related to the performance measurements from the processor collector monitoring process.

In another aspect, the present invention is a method for collecting performance measurements from a monitored system that includes a processor, the method comprising the steps of collecting by a process collector monitoring process performance measurements from a software application process running on said processor; collecting by a processor collector monitoring process running on said processor said performance measurements from said process collector monitoring process; and receiving by a system collector server performance scan data related to said performance measurements from said processor collector monitoring process.

### BRIEF DESCRIPTION OF THE DRAWING

For a more detailed understanding of the invention, for further objects and advantages thereof, reference can now be made to the following description, taken in conjunction with the accompanying drawings, in which:

FIG. 1 is a functional high-level network diagram of an exemplary performance management system implementing the preferred embodiment of the present invention;

FIG. 2 shows three types of measurements that may be used in conjunction with the preferred embodiment of the present invention; and

FIG. 3 is an exemplary high-level block diagram of the preferred variant of the present invention related to a preferred implementation of a process collector monitoring process incorporated into a monitored software application process.

### DETAILED DESCRIPTION OF THE PREFERRED EMBODIMENT

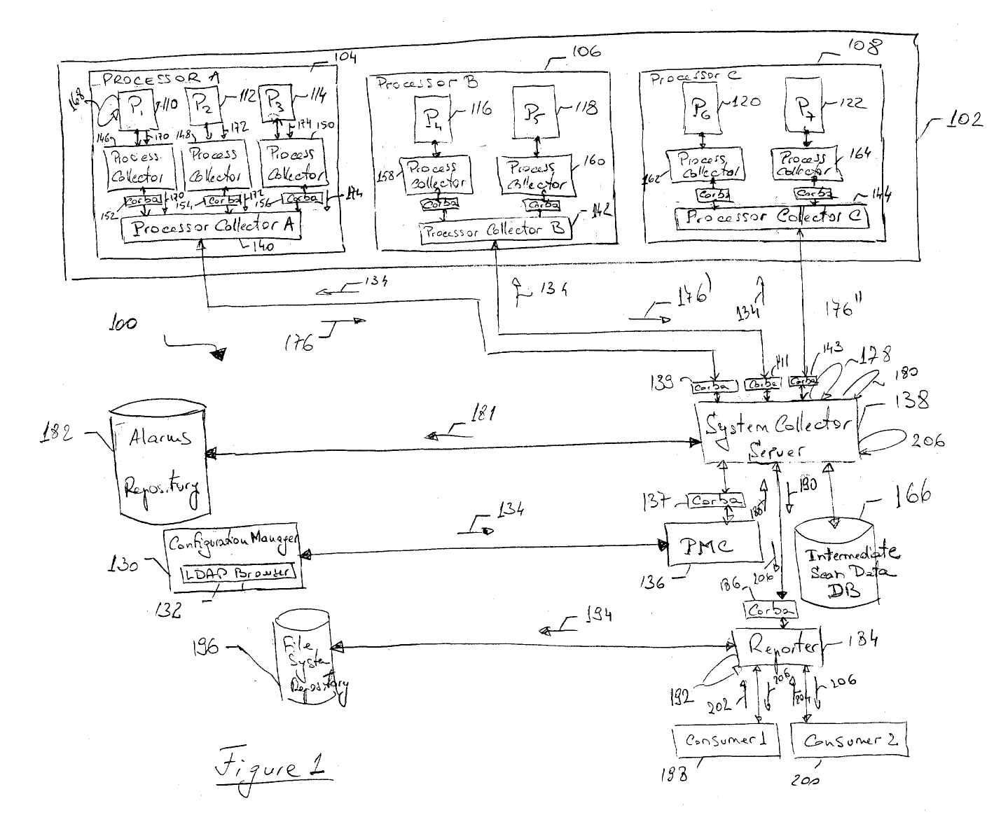

The innovative teachings of the present invention will be described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale. Referring now to FIG. 1, depicted therein is a functional high-level network diagram of an exemplary performance management system 100 implementing the preferred embodiment of the present invention. The performance management system 100 is used for monitoring the performance of a monitored system 102. For the purpose of the present exemplary scenario, it is assumed that the monitored system 102 comprises a computer system having, for example, three different processors A, B, and C, noted 104, 106, and 108 that may run various software application processes. For example, processor A 104 may run software application processes P1, P2, and P3 noted 110, 112, and 114, processor B 106 may run processes P4 and P5 noted 116, and 118, while processor C 104 may run processes P6 and P8 noted 120 and 122. Each one of these processes may be dedicated to performing specific tasks in relation with one or more software applications running on the computer system 102. For example, the shown processes 110-122 may be processes related to a software application running on a cellular telecommunications node like a Home Location Register (HLR) or a Service Control Point (SCP).

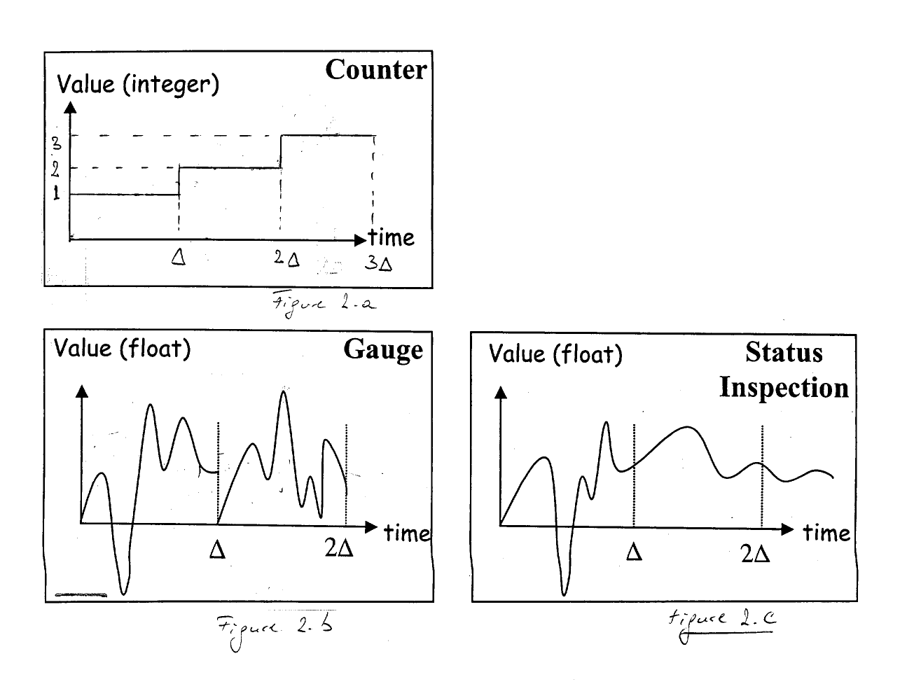

In order to collect performance-related measurements from the monitored system 102, according to the preferred embodiment of the present invention, various types of measurements may be set by a network administrator in the invented performance management system for acquiring information about its perfromance. Each such type of measurement may also be associated with a threshold level at which an alarm notification can be issued. Reference is now made to FIG. 2, wherein there are shown three types of measurements that may be used in conjunction with the present invention:

FIG. 2.a shows a counter measurement, which is a measurement type that can be used to report cumulative incremental integer variables. A counter may be a sum of individual values, and thus may represent an accumulated value over a period of time. An example of a counter measurement may be an integer number of treated messages during a certain time, or an integer number of registered subscribers requesting a given service during a given time period;

FIG. 2.b shows a gauge measurement, which represents a real valued (i.e. float) dynamic variable that may change in either direction. A gauge may be used to measure the mean value of a given parameter. An example of a gauge may be a percentage of use of a given processor; and

FIG. 2.c shows a status inspection measurement, which is a real valued measurement of an instant value that may be used for high frequency sampling of internal counters at predefined rates. An example of status inspection measurements may be an instant snapshot of the available memory in a system.

Reference is now made back to FIG. 1, wherein according to the present invention, a network administrator may use a configuration manager 130 including a Lightweight Directory Access Protocol (LDAP) browser 132, in order to define performance scan attributes for monitoring the performance of the computer system 102. The performance scan attributes may comprise a plurality of measurement parameters of the types described hereinbefore, a scan period for each such measurement parameter, a definition of various types of alarms including the alarm type and its destination for at least a number of measurements, and a number of threshold values for generating alarms related to each such measurement. The configuration manager 130 includes the defined performance scan attributes in configuration data 134 which is sent for configuring the performance monitoring of various components of the monitored computer system 102.

The configuration manager 130 sends the configuration data 134 to a Performance Management Configuration module (PMC) 136, which is responsible for deploying the configuration data 134 toward the monitored computer system 102. The PMC 136 is also responsible for deploying any updates made via the configuration manager 130 to the performance scan attributes of the monitored computer system 102. The PMC 136 may connect to a system collector server 138 via a Corba channel interface 137. The system collector server 138 is responsible for collecting and temporarily storing the measurement scan data from the monitored computer system 102. For this purpose, the system collector server may preferably register with the PMC 136 its interest in receiving any update of the configuration data made for the system 102. Thus, when the system collector server starts operating, or when an update of the configuration data occurs, the PMC 136 retrieves the configuration data 134 from the configuration manager 130, it sends that data to the system collector server 138, that in turns relays the configuration data 134 to the monitored computer system 102, preferably via Corba channels 139, 141 and 143. In the present exemplary scenario, it is assumed that the configuration data 134 reaches the computer system 102, and that a processor collector monitoring process is configured based on the configuration data 134 on each one of the processors 104, 106 and 108 of the system 102 for monitoring the performance of each such processor. For example, a first processor collector monitoring process 140 is configured on the processor 104, a second processor collector monitoring process 142 on the processor 106, and a third processor collector monitoring process 144 on the processor 106. According to the invention, the configuration data further configures, on each processor 104-106, a process collector monitoring process for each active application process, wherein each such process collector connects to its corresponding processor collector. In the present example, a first process collector monitoring process 146 is configured on processor 104 and also connects to the first running process 110. Likewise, a second process collector monitoring process 148 is configured for processor 104 and also connects to the second running process 112, and a third process collector monitoring process 150 is configured on the same processor 104 and connects to the third running process 114. The process collector monitoring processes 146, 148, and 150 may connect to the processor collector monitoring process 140 via Corba interfaces 152, 154, and 156. Similar configurations are also established in relation to processors 106 and 108 for the same purposes of monitoring the performance of these processors and their active processes 116, 118, 120, and 122 by configuring based on the configuration data 134 processor collectors 142 and 144, as well as process collectors 158, 160, 162, and 164, as shown.

According to the preferred embodiment of the present invention, the process collector monitoring processes 146-164 are software modules or processes that are connected to software application processes like processes 110-122, and are responsible for collecting various measurements from these application processes, and to forward them to their corresponding processor collector monitoring process 140-144 at the end of their internal scan period. The processor collector monitoring processes 140-144 are used to collect performance scan data from an entire processor from their cooperating process collectors 146-164, and to report that data to the system collector server 138 at the end of their own internal scan period. Finally, the system collector server 138 is yet another monitoring process or functionality responsible for gathering the performance scan data from all the processors of the system 102 via the various processor collectors 140-144 and for storing that data into an intermediate scan data database 166. The system collector server 138 is also responsible for pulling the scan data from the database 166 when requested. It is to be noted that although the system collector server 138 illustrated in FIG. 1 is shown as only receiving performance scan data from processors of one single computer system 102, the server may receive performance scan data from processors of other systems as well.

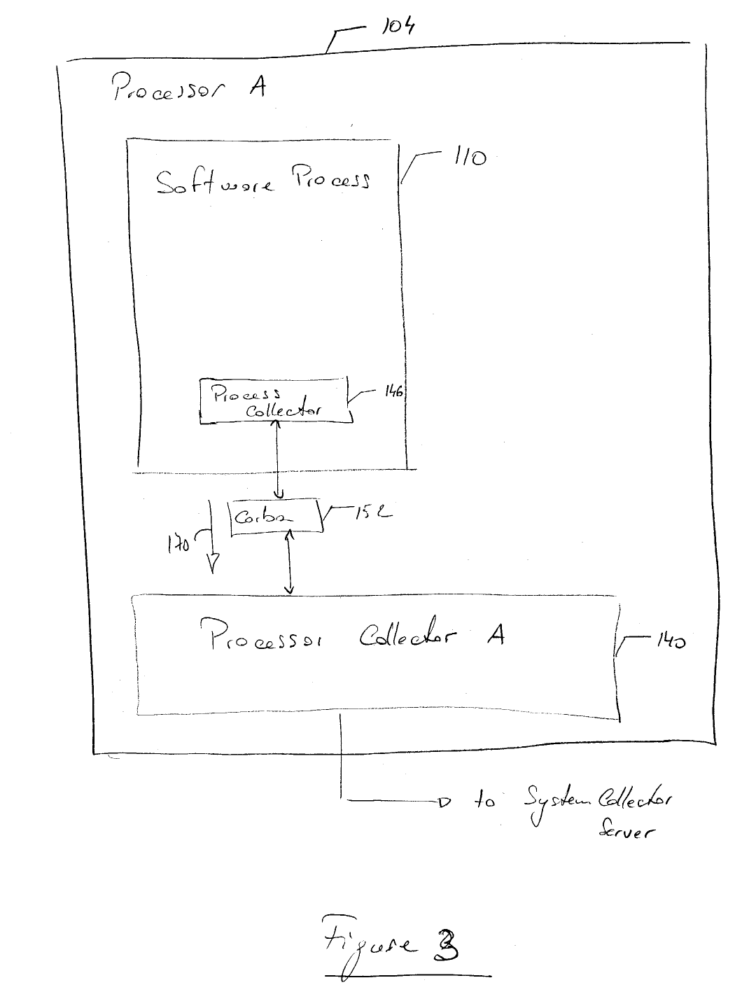

According to a variant of the preferred embodiment of the present invention, both the process collector monitoring processes 146-164 and the processor collector monitoring processes 140-144 are installed at the initial configuration of the monitored computer system 102, and are automatically loaded and run upon the start of the operation of the system 102, with their initial configuration data. Updated configuration data 134 may further be deployed for both the process collector monitoring processes 146-164 and the processor collector monitoring processes 140-144, as described hereinbefore, for altering their performance measurements' configuration. According to this preferred variant, the process collector monitoring processes 146-164 may be incorporated or attached to their corresponding monitored software processes 110-122, in order to facilitate data acquisition. For example, with reference being now made to FIG. 3, there is shown an exemplary high-level block diagram of the preferred variant of the present invention related to the process collector monitoring process, wherein the process collector monitoring process 146 is incorporated into the monitored software process 110, which performance it monitors.

With reference being now made back to FIG. 1, for the purpose of the present exemplary scenario, it is first assumed that at least a software application process 110 is running on processor 104, action 168. The process collector monitoring process 146 is running on the same processor 104, is configured based on the configuration data as described hereinbefore, and monitors the activity of the software application process 110 by monitoring various counters, gauges and status inspection measurements related to the process 110. When the performance scan period of the process collector 146 terminates, the former receives the values of these measurements from the process 110 through the Corba channel interface 152, action 170. Then, when a performance scan period of the processor collector 140 also terminates, the processor collector 140 receives the same measurements 170 from the process collector 146. At the same time, the processor collector 140 may also receive from the other process collectors 148 and 150 from the processor 104 yet other measurements 172 and 174 related to the remaining processes 112 and 114 running on the processor 104. Upon receipt the measurements 170-174, and depending upon the type of the measurement, the processor collector 140 may proceed to an aggregation of certain measurements. For example, in the case of a counter measurement designating the number of treated subscribers (for example, when the computer system 102 is a cellular telecommunications node application), each process collector 146-150 may report in the measurements 170-174 having treated 100, 200, and respectively 300 subscribers for the given time period. In this circumstance, the processor collector 140 may perform a sum calculation and calculate the sum of 600 subscribers having been treated by the processor 104. Alternatively, other types of calculations can be performed when aggregating the data from different process collectors, such as for example computing an average or any other type of arithmetical calculation. It is to be noted that although an aggregation of the performance scan data 170 may be performed by a process collector 140, that aggregation is optional and can therefore also be skipped.

At the end of the performance scan period of the process collector monitoring process 140, and once the necessary aggregation has been performed, the processor collector monitoring process 140 sends a processor performance scan data 176 to the system collector server 138. It is to be noted that in case the monitored computer system 102 is a multi-processor system like the one shown in FIG. 2, the system also comprises other processors like processors 106 and 108, which performance is monitored in a similar manner as described hereinbefore by process collector monitoring processes 116, 118, 120 and 122, which report their measurements to processor collector monitoring processes 142 and 144. The formers also report performance scan data 176′ and 176″ to the same system collector server 138.

Upon receipt of the data 176, 176′, and 176″, the system collector server 138 may also perform some type of data aggregation, action 178, based on principles similar to the aggregation described hereinbefore in relation to the processor collector 140. The system collector server 138 may also further analyze the threshold values initially defined by the configuration manager 130, and depending upon the values, may create or clear alarm notifications. In the present example, it is assumed that in action 180, the system collector server 138 detects an aggregated counter measurement received from the processor collector 140 in action 176 as being above a predefined threshold value, in which case the server 138 issues a new alarm notification 181, which is sent to the alarm repository 182 for storage.

According to the present invention, a reporter 184 may connect to the system collector server 138, via a Corba interface 186. The reporter 184 is in charge of logging and saving the performance scan data into a file at the end of its own scan period. At that time, the reporter 184 may request from the system collector server 138, action 188, the intermediate performance scan data stored in the database 166, to which the server 138 responds in action 190 by sending the intermediate performance scan data stored in the database 166 since the last report. The reporter 184 receives the performance scan data in action 190, and in action 192 may reformat the performance scan data into an XML format according to the technical specification 3G Performance Management (PM) Release 1999 3GPP TS 32.104 V3.4.0, published by the Third Generation Partnership Project (3GPP) in December 2000, which is herein included by reference. In action 194, the reporter 184 sends the data file with the performance scan data in the XML format for storage to a file system repository 196. By regularly requesting the intermediate scan data from the server 138, the reporter 184 provisions the file system repository 196 with up-to-date performance monitoring data related to the monitored system 102.

Performance data consumers 198 and 200 may connect and register to the reporter 184 with requests 202 and 204 for various portions of the intermediate performance scan data stored on the intermediate scan data database 166. The requests 202 and 204 may also comprise a time granularity based on which consumers 198 and 200 desire to receive the scan data report. At intervals set by the requests, the reporter 184 extracts from the intermediate scan data database 166 the portions of scan data requested in the requests 198 and 200, action 206, and relays the data to the requesting consumers 198 and 200.

Based upon the foregoing, it should now be apparent to those of ordinary skill in the art that the present invention provides an advantageous solution, which offers a convenient scalable and configurable performance management method and system for monitoring the performance of a computer system. Although the system and method of the present invention have been described in particular reference to certain exemplary implementations, it should be realized upon reference hereto that the innovative teachings contained herein are not necessarily limited thereto and may be implemented advantageously with other configurations. For example, with reference being made to FIG. 1, although the system collector server 138 is represented apart form the monitored computer system 102, it should be noted that this is only one possible implementation, and that the server 138 may also be implemented, for example, as a system collector server process running on any one of the processors of the computer system 102, alike the processor collector monitoring processes 140-144. In such an implementation, the system collector server 138 has the same connections and performs the same functions as described hereinbefore. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A Performance Management System (PMS) comprising:
a monitored computer system that includes a processor;
a software application process running on said processor;
a process collector monitoring process collecting performance measurements from said software application process;
a processor collector monitoring process running on said processor and connected to said process collector monitoring process, said processor collector monitoring process collecting said performance measurements from said process collector monitoring process; and
a system collector server collecting performance scan data related to said performance measurements from said processor collector monitoring process.

2. The PMS of claim 1, wherein the PMS comprises:
a plurality of software application processes running on said processor, wherein said software application process is one of said plurality of software application processes; and
a plurality of process collector monitoring processes running on said processor, wherein said process collector monitoring process is one of said plurality of process collector monitoring processes, and wherein each process collector monitoring process of said plurality of process collector monitoring processes collects performance measurements from one software application process;
wherein said processor collector monitoring process collects said performance measurements from each one of said plurality of process collector monitoring processes, creates performance scan data by aggregating certain ones of said performance measurements based on a type of said performance measurements and reports said performance scan data to said system collector server.

3. The PMS of claim 2, wherein said performance measurements include a counter measurement.

4. The PMS of claim 2, wherein said performance measurements include a gauge measurement.

5. The PMS of claim 2, wherein said performance measurements include a status inspection measurement.

6. The PMS of claim 2, wherein each one of said plurality of software application processes includes a corresponding one of said plurality of process collector monitoring processes.

7. The PMS of claim 2, further comprising:
a configuration manager connected to said system collector server for configuring said performance measurements, said configuration manager receiving performance scan attributes from a system administrator and configuring said plurality of process collector monitoring processes and to said processor collector monitoring process using said performance scan attributes.

8. The PMS of claim 7, wherein said configuration manager connects to said system collector server through a performance management configurator module.

9. The PMS claimed in claim 1, wherein said system collector server detects that at least one performance measurement included in said performance scan data is above a predefined threshold value, and issues an alarm notification.

10. The PMS claimed in claim 9, further comprising:
an alarm repository receiving said alarm notification from said system collector server and storing said alarm notification.

11. The PMS claimed in claim 2, further comprising:
a file system repository; and
a reporter receiving said performance scan data from said system collector server, converting said performance scan data into an XML file format, and saving said performance scan data under said XML format onto said file system repository.

12. The PMS claimed in claim 11, further comprising:
a performance scan data consumer that connects to said reporter and sends a query for receiving a certain portion of said performance scan data to said reporter based on a time granularity;
wherein said reporter retrieves from said file system repository said certain portion of said performance scan data based on said query, and further reports to said consumer said certain portion of said performance scan data at time intervals defined by said time granularity.

13. A method for collecting performance measurements from a monitored system that includes a processor, the method comprising the steps of:
collecting by a process collector monitoring process performance measurements from a software application process running on said processor;
collecting by a processor collector monitoring process running on said processor said performance measurements from said process collector monitoring process; and
receiving by a system collector server performance scan data related to said performance measurements from said processor collector monitoring process.

14. The method of claim 1, wherein on said processor run a plurality of software application processes including said software application process and a plurality of process collector monitoring processes including said process collector monitoring process, wherein the method further comprises the steps of:
collecting by each process collector monitoring process of said plurality of process collector monitoring processes performance measurements from one software application process;
collecting by said processor collector monitoring process said performance measurements from each one of said plurality of process collector monitoring processes;
creating performance scan data by aggregating certain ones of said performance measurements based on a type of said performance measurements; and
reporting said performance scan data to said system collector server.

15. The method of claim 14, wherein said performance measurements include a counter measurement.

16. The method of claim 14, wherein said performance measurements include a gauge measurement.

17. The method of claim 14, wherein said performance measurements include a status inspection measurement.

18. The method of claim 14, wherein each one of said plurality of software application processes includes a corresponding one of said plurality of process collector monitoring processes.

19. The method of claim 14, further comprising the steps of:
receiving by a configuration manager performance scan attributes from a system administrator; and
configuring said plurality of process collector monitoring processes and said processor collector monitoring process using said performance scan attributes.

20. The method of claim 19, wherein said configuration manager connects to said system collector server through a performance management configurator module.

21. The method of claim 13, further comprising the steps of:
detecting that at least one performance measurement included in said performance scan data is above a pre-defined threshold value; and
issuing an alarm notification.

22. The method of claim 21, further comprising the steps of:
receiving by an alarm repository said alarm notification from said system collector server; and
storing said alarm notification on said alarm repository.

23. The method claimed in claim 14, further comprising the steps of:
receiving by a reporter said performance scan data from said system collector server;
converting said performance scan data into an XML file format;
storing said performance scan data under said XML format onto said file system repository.

24. The method claimed in claim 23, further comprising:
sending by a performance scan data consumer to said reporter a query for receiving a certain portion of said performance scan data based on a time granularity;
retrieves from said file system repository said certain portion of said performance scan data based on said query; and
reporting to said consumer said certain portion of said performance scan data at time intervals defined by said time granularity.
